(19) United States
(12) Patent Application Publication
(10) Pub. No.: US 2010/0114470 A1
(43) Pub. Date: May 6, 2010

(54) ROUTE SEARCH APPARATUS, ROUTE SEARCH METHOD, ROUTE SEARCH PROGRAM AND STORAGE MEDIUM

(75) Inventor: Ippei Nambata, Kawagoe-Shi (JP)

Correspondence Address: YOUNG & THOMPSON, 209 Madison Street, Suite 500, Alexandria, VA, 22314, US

(73) Assignee: PIONEER CORPORATION, Tokyo (JP)

(21) Appl. No.: 12/442,827

(22) PCT Filed: Oct. 10, 2006
(86) PCT No.: PCT/JP2006/320220

§ 371 Date: Mar. 25, 2009

(51) Int. Cl. G01C 21/36

(52) U.S. Cl. 701/200

(57) ABSTRACT

A route searching device is composed as a terminal device for a PC or the like which carries out route searching by making use of a navigation device and map data. Route calculation data used for the search of a route include candidate link data indicative of a link subjected to calculation for a candidate route by way of a node in addition to node data and link data. A route calculating means carries out route calculations for a candidate link, as a subject, that candidate link data indicate for a node in which the candidate link data exist and for a link, as a subject, along a route in which no candidate link data exist.

### TECHNICAL FIELD

The present invention relates to a route search technique using map data.

### BACKGROUND TECHNIQUE

A route search function is provided in a car navigation apparatus and a map supplying application on the Internet. The route search function is a function to automatically calculate a geographic route from a departure place to a destination with using map data and to show the user the geographic route.

Generally speaking, long-distance route calculation needs time because of a large number of candidate roads. Normally, the route calculation data is hierarchically structured. At the time of the long-distance route calculation, high-speed calculation is realized by using data including only main roads. However, even though the data is limited to only the main roads, there are considerable number of road links in the whole country. Hence, in calculating the long-distance route which passes plural prefectures, since all the road links of the main roads are subjected to the calculation, a large amount of calculation becomes necessary.

There is known a method of including special data other than normal data of nodes and links in route calculation data for the purpose of the high-speed long-distance route calculation. For example, there is known a method of preparing data storing only links necessary for the route calculation of the combination of a departure area and a destination area and executing the route calculation with using the data.

In Patent Reference-1, there is proposed a method which will be described below. First, an area on a map is divided into plural search segments, and a candidate road such as a highway and a national road expected to be generally used and a connection point (exit/entrance) to the candidate road in each search segment are determined and stored in advance. At the time of the route calculation, the candidate road, corresponding to the search segment including the start point and the end point and the connection point to the candidate road are called out, and the route calculation is executed with using only the candidate road.

Patent Reference-1: Japanese Patent Application Laid-open under No. H11-64023

### DISCLOSURE OF INVENTION

### Problem to be Solved by the Invention

However, by the above-mentioned method, the amount of special data included in the route calculation data becomes large. Additionally, when it becomes necessary to update the route calculation data in correspondence with the change of the roads, the amount of data to be updated also becomes large.

The present invention has been achieved in order to solve the above problem. It is an object of this invention to realize high-speed long-distance route calculation without excessively increasing the amount of data for the route calculation.

In the invention according to claim 1, a route search apparatus includes: a storage unit which stores route calculation data that includes link data showing a link corresponding to a road, node data showing a node corresponding to a predetermined point on the road and candidate link data showing a link to be used in calculation of a candidate route via the node; and a route calculation unit which executes route calculation with using the route calculation data, wherein the route calculation unit executes the route calculation by using the link shown by the candidate link data at the node at which the candidate link data exists and by using a link along a road at the node at which the candidate link data does not exist.

In the invention according to claim 6, a route search method includes a route calculation process which executes route calculation with using route calculation data that includes link data showing a link corresponding to a road, node data showing a node corresponding to a predetermined point on the road and candidate link data showing a link to be used in calculation of a candidate route via the node, wherein the route calculation process executes the route calculation by using the link shown by the candidate link data at the node at which the candidate link data exists and by using the link along a road at the node at which the candidate link data does not exist.

In the invention according to claim 7, a route search program which is executed in a terminal apparatus includes: a storage unit which stores route calculation data that includes link data showing a link corresponding to a road, node data showing a node corresponding to a predetermined point on the road and candidate link data showing a link to be used in to calculation of a candidate route via the node; and a computer, and which makes the computer function as a route calculation unit that executes route calculation with using the route calculation data, wherein the route calculation unit executes the route calculation by using the link shown by the candidate link data at the node at which the candidate link data exists and by using the link along a road at the node at which the candidate link data does not exist.

In the invention according to claim 8, there is provided a storage medium which stores route calculation data that includes link data showing a link corresponding to a road, node data showing a node corresponding to a predetermined point on the road and candidate link data showing a link to be used in calculation of a candidate route via the node.

### BRIEF DESCRIPTION OF THE DRAWINGS

FIG. 1 schematically shows structure of map data used in an embodiment of the present invention;

FIG. 2 shows an example of route calculation data structure;

FIG. 3 shows an example of node data structure;

FIGS. 4A and 4B show a relation between link/node and candidate link data;

FIGS. 5A to 5C schematically show examples of the candidate link data;

FIGS. 6A to 6D show examples of a determination method of a link along a road;

FIG. 7 shows an example of an intermediate destination table;

FIG. 8 is a block diagram schematically showing a configuration of a navigation apparatus according to the embodiment;

FIG. 9 is a flow chart of a route search process according to the embodiment;

FIGS. 10A and 10B show examples of route search according to the embodiment; and

FIGS. 11A to 11C show modifications of the candidate link data.

### BRIEF DESCRIPTION OF THE REFERENCE NUMBER

120 Map data
122 Map display data
124 Route calculation data
125 Node data
126 Link data
131 and 132 Candidate link data
200 Navigation apparatus

### DETAILED DESCRIPTION OF THE PREFERRED EMBODIMENTS

According to one aspect of the present invention, there is provided a route search apparatus including: a storage unit which stores route calculation data that includes link data showing a link corresponding to a road, node data showing a node corresponding to a predetermined point on the road and candidate link data showing a link to be used in calculation of a candidate route via the node; and a route calculation unit which executes route calculation with using the route calculation data, wherein the route calculation unit executes the route calculation by using the link shown by the candidate link data at the node at which the candidate link data exists and by using a link along a road at the node at which the candidate link data does not exist.

The above route search apparatus can be formed as a terminal apparatus which executes the route search with using map data in a navigation apparatus, on the Internet or in a storage medium, such as a PC. The route calculation data used for the route search includes not only the node data and the link data but also the candidate link data showing the link to be used in the calculation of the candidate route via the node. The route calculation unit executes the route calculation by using the link shown by the candidate link data at the node at which the candidate link data exists and by using the link along the road as for the node at which the candidate link data does not exist.

In this manner, the principle is to choose the link along the road in the route calculation. Only when the link other than the link along the road is used in the calculation, the candidate link data showing such link is prepared in association with the node. Thus, the candidate link data prepared and stored for the purpose of the high-speed route calculation only exists in correspondence with the necessary node, and the amount of data can be suppressed. In addition, the route calculation unit may prescribe that only the link along the road is used in the calculation at the node at which the candidate link data does not exist. Therefore, the rapid calculation becomes possible.

In a manner of the above route search apparatus, the candidate link data may be prepared for each search condition, and the route calculation unit may execute the route calculation with using candidate link data corresponding to a search condition designated by a user. As the search condition, there are “Priority to highway”, “Avoid highway”, Priority to time” and “Priority to distance”, for example. Since the optimum route becomes different for each search condition, it is preferable that the candidate link data is also prepared for each search condition.

In another manner of the above route search apparatus, the route calculation unit may use only the link showing a destination, out of the links shown by the candidate link data. Even though the link is shown by the candidate link data, the link showing no correspondent destination is excluded from the subject of the calculation of the candidate route. Thereby, the amount of calculation can be reduced.

In still another manner of the above route search apparatus, the route calculation data may be prepared for each of plural layers corresponding to different scales, and the candidate link data may be prepared for the layer corresponding to at least a widest map. Thereby, especially in the long-distance route search, it becomes possible to realize the high-speed calculation of the route via the highway and the main road included in the wide map.

In still another manner of the above route search apparatus, the route calculation data may include an intermediate destination table showing correspondence of a final destination and an intermediate destination positioned on a route to the final destination, and the route calculation unit may calculate the candidate route by prescribing the final destination and the intermediate destination as the destinations. Since many destinations set in correspondence with each link exist in the route calculation data, the correspondence of the final destination and the intermediate destination is stored as the table, and the intermediate destination is set in the candidate link data. Thereby, the amount of candidate link data can be reduced.

According to another aspect of the present invention, there is provided a route search method including a route calculation process which executes route calculation with using route calculation data that includes link data showing a link corresponding to a road, node data showing a node corresponding to a predetermined point on the road and candidate link data showing a link to be used in calculation of a candidate route via the node, wherein the route calculation process executes the route calculation by using the link shown by the candidate link data at the node at which the candidate link data exists and by using the link along a road at the node at which the candidate link data does not exist.

By the method, the high-speed route calculation can be realized without excessively increasing the amount of route calculation data.

According to still another aspect of the present invention, there is provided a route search program which is executed in a terminal apparatus including: a storage unit which stores route calculation data that includes link data showing a link corresponding to a road, node data showing a node corresponding to a predetermined point on the road and candidate link data showing a link to be used in calculation of a candidate route via the node; and a computer, and which makes the computer function as a route calculation unit that executes route calculation with using the route calculation data, wherein the route calculation unit executes the route calculation by using the link shown by the candidate link data at the node at which the candidate link data exists and by using the link along a road at the node at which the candidate link data does not exist.

By executing the program in the terminal apparatus, the route calculation apparatus according to the present invention can be realized. The terminal apparatus may include the navigation apparatus and the PC.

According to still another aspect of the present invention, there is provided a storage medium which stores route calculation data that includes link data showing a link corresponding to a road, node data showing a node corresponding to a predetermined point on the road and candidate link data showing a link to be used in calculation of a candidate route via the node. By obtaining the route calculation data from the storage medium, the rapid route calculation becomes possible.

### EMBODIMENT

Now, a description will be given of a preferred embodiment of the present invention with reference to attached drawings.

### [Map Data]

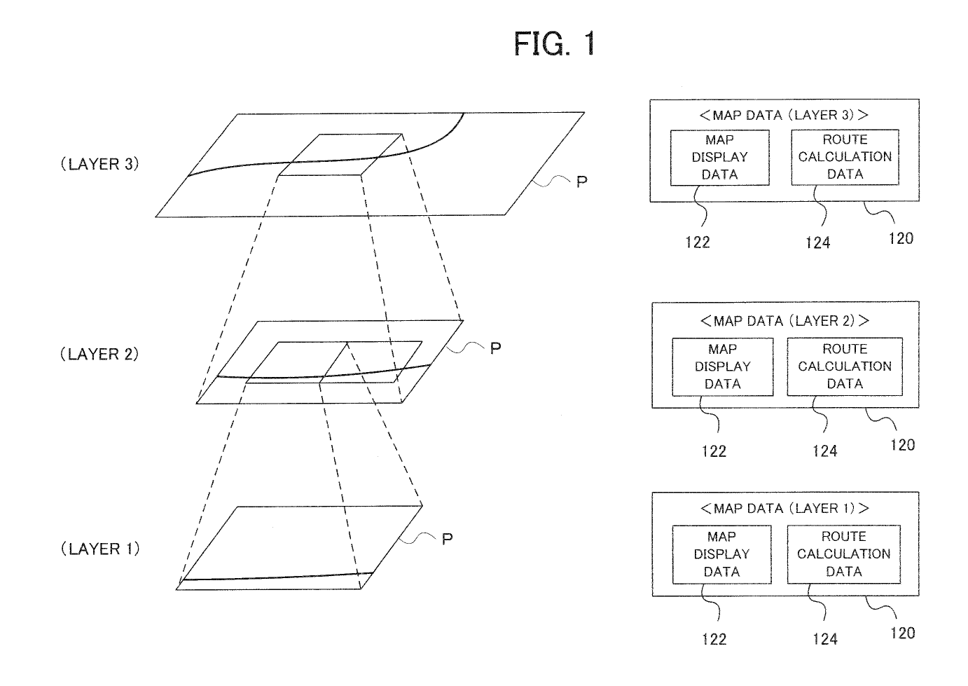

FIG. 1 schematically shows a configuration of map data used in this embodiment. The map data is formed as a hierarchic structure including plural layers corresponding to plural different scales. FIG. 1 illustrates the map data including three layers for convenience of explanation, but the map data may include much more layers. In each layer, a single unit of the map data is referred to as Parcel P. In FIG. 1, a layer 3 is the highest layer, and corresponds to the widest map. A layer 1 is the lowest layer, and corresponds to the most detailed map.

Map data 120 is separately prepared for each layer, and includes map display data 122 and route calculation data 124, respectively. The map display data 122 is used for displaying a map image to the user, and mainly includes image data corresponding to the map. The route calculation data 124 is used for route calculation by a route search function.

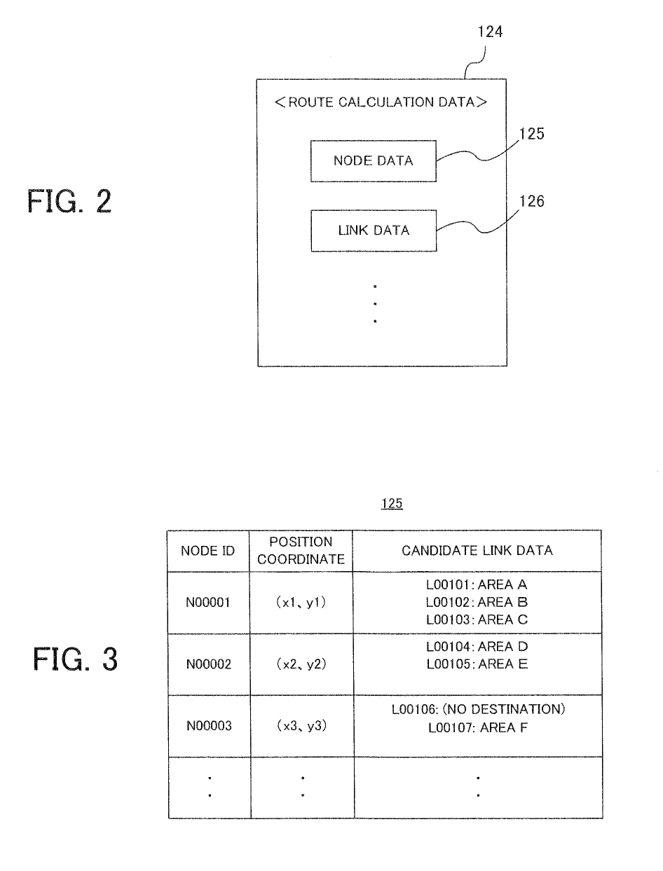

FIG. 2 shows the configuration of the route calculation data. The route calculation data 124 includes node data 125 and link data 126. The node corresponds to a predetermined point such as an intersection on a rode, and the node data 125 shows the node. Meanwhile, the link corresponds to a segment sectioned by the intersection on the road, and the link data 126 shows the link.

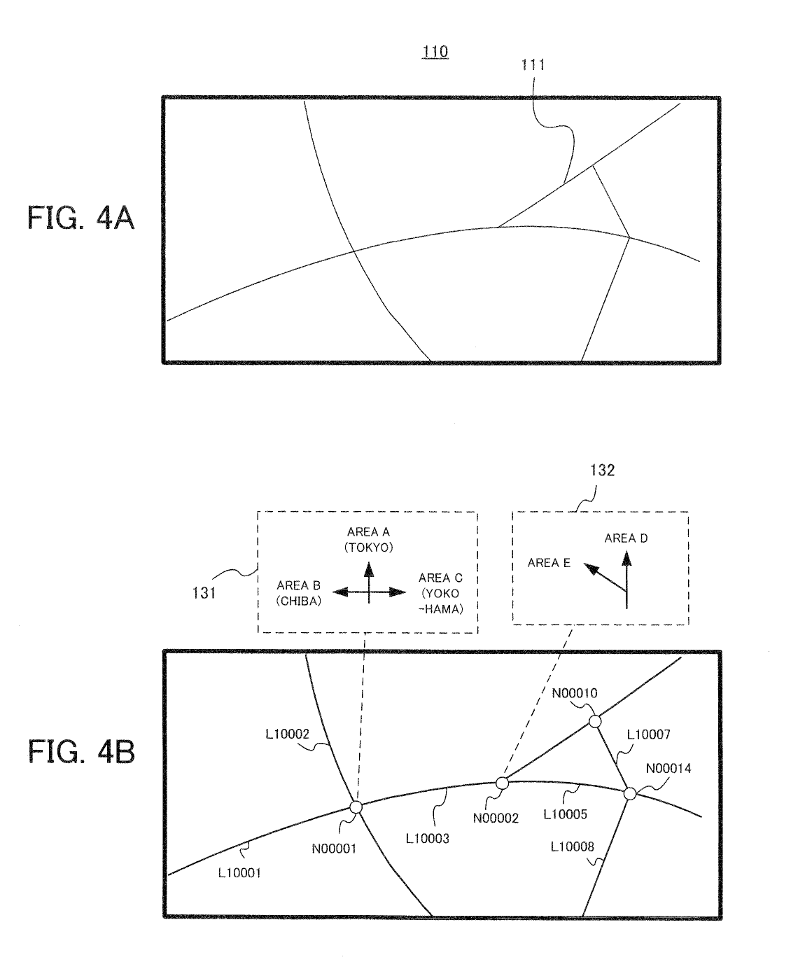

FIGS. 4A and 4B show examples of the nodes and the links. A map including plural roads 11, shown in FIG. 4A, is formed by the plural nodes and links as shown in FIG. 4B. In FIG. 4B, each node is shown by a node ID (e.g., N00001), and each link is shown by a link ID (e.g., L00001).

FIG. 3 shows the structure of the node data. The node data 125 includes a geographical position coordinate (latitude and longitude) for each node ID corresponding to each node. Some nodes include candidate link data. The candidate link data shows a candidate link. The candidate link is a link used at the time of calculating a candidate route to the destination via the node in the route calculation.

As for a certain node, whether or not the candidate link exists is determined as described below. As for the certain node, when the link up to the specific destination is the link along the road, the candidate link data is not prepared. Meanwhile, when it is necessary to travel in the link other than the link along the road in order to travel to a specific destination, the candidate link data is prepared so as to show the relation between the link and the destination. Thus, in a route calculation process which will be described later, it is determined whether or not the candidate link data exists for each node existing on the candidate route. When no candidate link data exists, the candidate route is calculated by using only the link along the road. Meanwhile, when the candidate link data exists, the candidate route is calculated by using the candidate link shown by the candidate link data. In the route calculation, in principle, only the link along the road is subjected to the route calculation for each node. As an exception, the candidate link shown by the candidate link data is subjected to the route calculation for the node at which the candidate link data exists. Thereby, it becomes unnecessary to prepare and store the candidate link data subjected to the route calculation for all the nodes. Thus, it becomes possible to reduce the amount of special data to be prepared and stored in advance for the purpose of the high-speed route calculation.

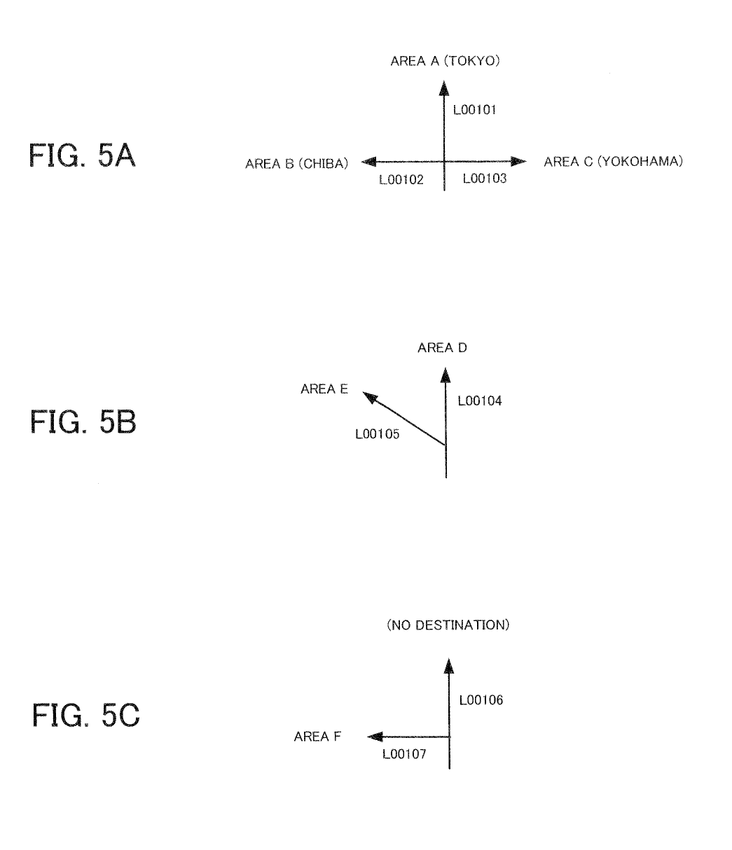

Concretely, the candidate link data shows correspondence of the candidate link connected to each node and the destination corresponding to the candidate link. FIG. 5A shows the candidate link data of the node N000001 shown in FIG. 3. As for the node N00001, there are three travelable candidate links L00101, L00102 and L00103. The destination of the candidate link L00101 is an area A (TOKYO), and the destination of the candidate link L00102 is an area B (CHIBA). The destination of the candidate link L00103 is an area C (YOKOHAMA).

Similarly, FIG. 5B shows the candidate link data of the node N00002 shown in FIG. 3. As for the node N00001, there are two travelable candidate links L00104 and L00105. The destination of the candidate link L00104 is an area 9, and the destination of the candidate link L00102 is an area E.

In the candidate link data, the destination is not always set to all the candidate links connected to the node. Namely, as for the certain node, the destination is set only to the candidate link, out of the plural candidate links connected to the node, to be included in the candidate route via the node. Therefore, the link to which the destination is not set is excluded from the object of the candidate route calculation. Generally, the link to which the destination is not set is the link along the road interrupted in the halfway, and no destination exists ahead. For example, FIG. 5C shows the candidate link data corresponding to a node N00003 shown in FIG. 3. As for the node N00003, there are two travelable candidate links L00106 and L00107, but the destination is not set to the candidate link L00106. Hence, as for the route calculation, when the destination of the route calculation corresponds to an area F, only the candidate link L00107 is considered to calculate the candidate route at the node N00003.

FIG. 4B schematically shows such a state that the candidate link data shown in FIG. 3 are associated with the nodes. The candidate link data 131 shown in FIG. 5A is associated with the node N00001, and the candidate link data 132 shown in FIG. 5B is associated with the node N00002.

The candidate link data can be prepared for each search condition which the user can designate in the route search function. As the search condition, there are such conditions as “PRIORITY TO TOLL ROAD” and “AVOID TOLL ROAD”, “USE FERRY” and “AVOID FERRY”, “PRIORITY TO TIME” and “PRIORITY TO DISTANCE”. This is because, even to the same destination, the calculated route is different in a different search condition. For example, even to the same destination, the routes to be suggested to the user are different in the cases of “PRIORITY TO TOLL ROAD” and “AVOID TOLL ROAD”. Therefore, the candidate link data is prepared for each condition.

In addition, as the actual data, the area (place name) included in the candidate link data is stored as a correspondent parcel ID (area ID).

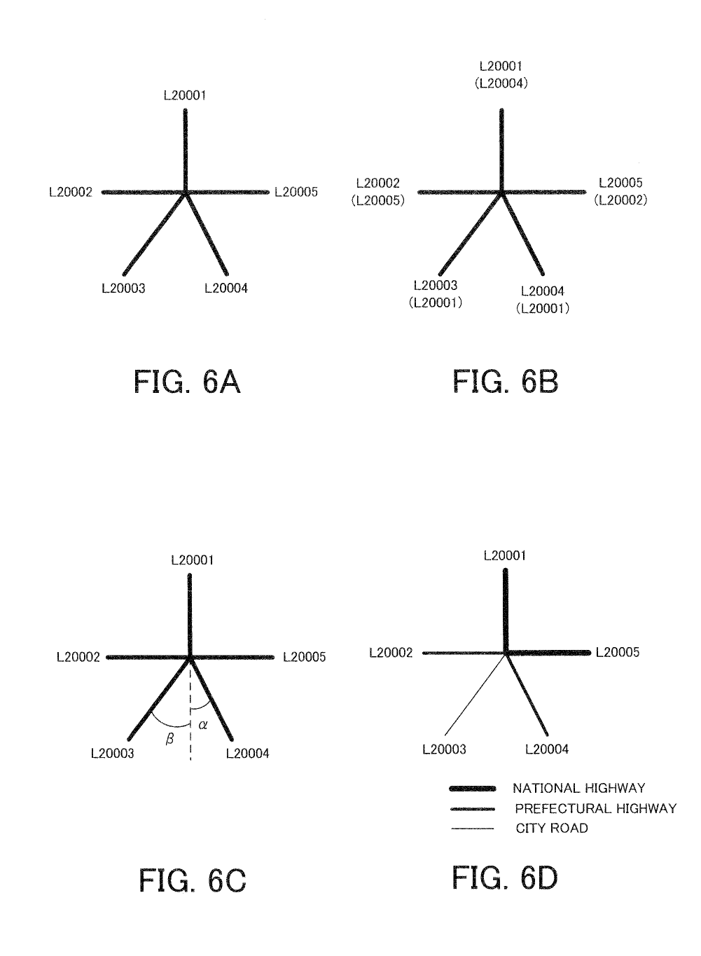

Next, a description will be given of the link along the road. As described above, in principle, only the link along the road is used in the route calculation at each node in the route calculation of this embodiment. Now, some examples of a method of determining the link along the road will be given and explained. It is assumed that there is an intersection at which five links L20001 to L20005 cross as shown in FIG. 6A.

A first example is a method of storing, in the link data of each link, a link number indicating the link along the road as to the link, as shown in FIG. 6B. In FIG. 6B, the link ID shown in a parenthesis of each link ID shows the link ID of the link along the road. For example, the link along the road for the link L20001 is the link L20004. In this manner, by storing the information of the link along the road in the link data and referring to the link data, the link along the road for each link can be determined.

A second example is a method of prescribing the link closest to the direction of going straight ahead from the link as the link along the road, based on the data of each link. In FIG. 6C, the direction of going straight ahead from the link L20001 is shown by a broken line. In this case, the link L20004 is shifted with respect to the direction of going straight ahead by an angle α, and the link L20003 is shifted with respect to the direction of going straight ahead by an angle β. Since the angle α< the angle β, the link along the road for the link L20001 is determined as the link L20004.

A third example is a method of determining the link in the same road type as the link along the road, based on the data of each link. In FIG. 6D, it is assumed that the links L20001 and L20005 are national roads, the links L20002 and L20004 are prefectural roads, and the link L20003 is a city road. In this case, the link along the road for the link L20001 is the link L20005 in the same road type (national road). In addition, the link along the road for the link L20002 is the link L20004 in the same road type (prefectural road).

In the present invention, the method of determining the link along the road is not limited to the above-mentioned examples. For example, some of the above-mentioned examples may be mixedly used, and the link along the road may be determined by a method other than the above-mentioned examples.

Next, a description will be given of replacing the destination in the case of using the candidate link data. As described above, the destination is set to each candidate link for the candidate link data. However, if all the correspondent destinations are set for each candidate link, the amount of data to be stored as the candidate link data becomes large. For example, in both cases of going to Nagoya from Tokyo and going to Osaka, Kobe and Hiroshima from Tokyo, the same link is sometimes used at a certain node. In this case, if all the destinations, e.g., Nagoya, Osaka, Kobe, Hiroshima, and . . . , are set as the destinations of the link in the candidate link data, the amount of data to be stored becomes large.

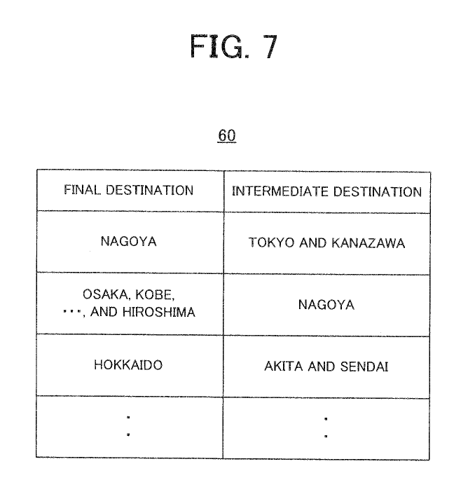

Therefore, in this embodiment, in the candidate link data, the intermediate destination is set as needed, and a table (referred to as “intermediate destination table”) showing the correspondence of the intermediate destination and the final destination is used to replace the destination. The intermediate destination is the destination positioned on the route up to the final destination. In the above example, in the case that the final destination is any one place of Osaka, Kobe and Hiroshima, Nagoya is gone through. Hence, while Osaka, Kobe or Hiroshima is the final destination, Nagoya is prescribed as the intermediate destination. FIG. 7 shows an example of the intermediate destination table. FIG. 7 is the example of the intermediate destination table in the case of starting from Tokyo.

With reference to FIG. 7, when the user designates “Osaka” as the final destination of the route search, the route search apparatus refers to the intermediate destination table, and executes the route calculation with using the links including not only “Osaka” but also “Nagoya” as the destination shown by each candidate link in the candidate link data. In this manner, by replacing the destination with using the intermediate destination table, it becomes unnecessary to set all the destinations of each candidate link in the candidate link data. Thus, the amount of data to be stored can be significantly reduced.

### [Navigation Apparatus]

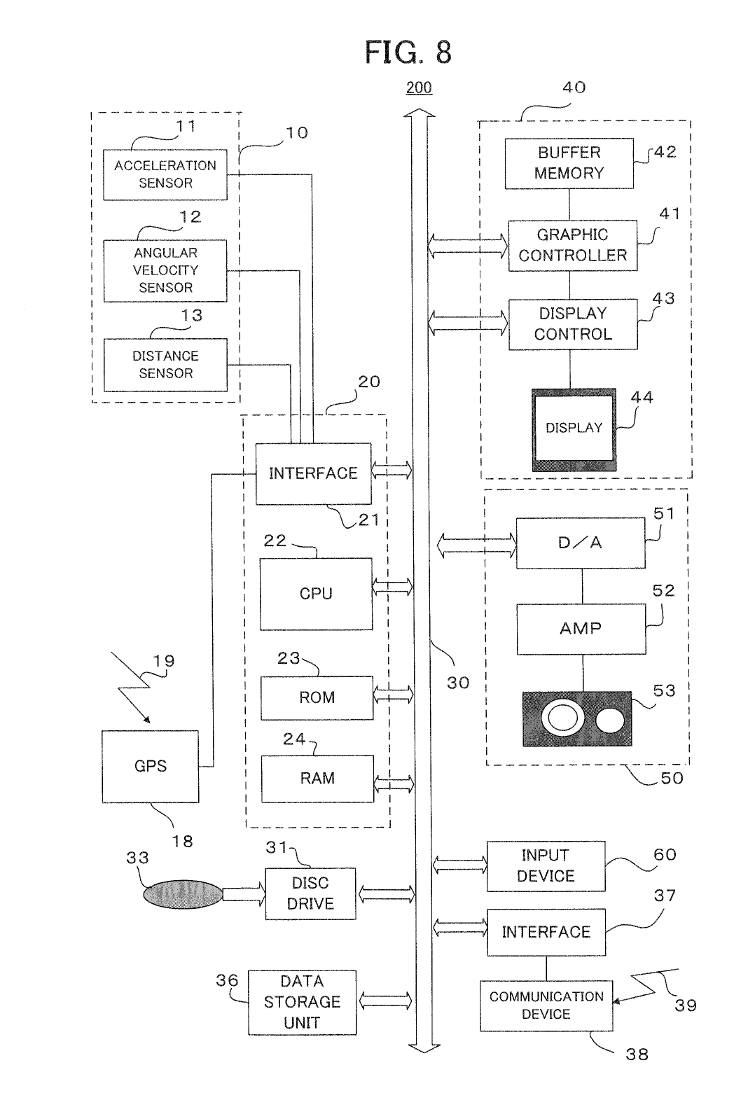

FIG. 8 shows a configuration of a navigation apparatus 200 according to an embodiment of the present invention. As shown in FIG. 8, the navigation apparatus 200 includes a stand-alone position measurement device 10, a GPS receiver 18, a system controller 20, a disc drive 31, a data storage unit 36, a communication interface 37, a communication device 38, a display unit 40, a sound output unit 50, and an input device 60.

The stand-alone position measurement device 10 includes an acceleration sensor 11, an angular velocity sensor 12 and a distance sensor 13. The acceleration sensor 11 includes a piezoelectric element, for example, and detects the acceleration degree of the vehicle and outputs the acceleration data. The angular velocity sensor 12 includes a vibration gyroscope, for example, and detects the angular velocity of the vehicle at the time of changing the direction of the vehicle and outputs the angular velocity data and the relative direction data. The distance sensor 13 measures vehicle speed pulses including a pulse signal generated with the wheel rotation of the vehicle.

The GPS receiver 18 receives an electric wave 19 for transmitting downlink data including position measurement data from plural GPS satellites. The position measurement data is used for detecting the absolute position of the vehicle from longitude and latitude information.

The system controller 20 includes an interface 21, a CPU (Center Processing Unit) 22, a ROM (Read Only Memory) 23 and a RAM (Random Access Memory) 24, and controls the entire navigation apparatus 200.

The interface 21 executes the interface operation with the acceleration sensor 11, the angular velocity sensor 12, the distance sensor 13 and the GPS receiver 18. Then, the interface 21 inputs the vehicle speed pulse, the acceleration data, the relative direction data, the angular velocity data, the GPS measurement data and the absolute direction data into the system controller 20. The CPU 22 controls the entire system controller 20. The ROM 23 includes a non-volatile memory (not shown) in which a control program for controlling the system controller 20 is stored. The RAM 24 readably stores various kinds of data such as route data preset by the user via the input device 60, and supplies a working area to the CPU 22.

The system controller 20, the disc drive 31 such as a CD-ROM drive or a DVD-ROM drive, the data storage unit 36, the communication interface 37, the display unit 40, the sound output unit 50 and the input device 60 are connected to each other via a bus line 30.

Under the control of the system controller 20, the disc drive 31 reads contents data such as sound data and video data from a disc 33 such as a CD and a DVD to output the contents data. The disc drive 31 may be the CD-ROM drive or the DVD-ROM drive, or may be a drive compatible between the CD and the DVD.

The data storage unit 36 includes HDD, for example, and stores various kinds of data used for a navigation process such as map data and facility data.

The communication device 38 includes an FM tuner, a beacon receiver, a mobile phone and a dedicated communication card, for example, and obtains road traffic information such as traffic jam and traffic information and other information delivered from a VICS (Vehicle Information Communication System) center via the communication interface 37.

The display unit 40 displays various kinds of display data on a display device such as a display under the control of the system controller 20. Concretely, the system controller 20 reads the map data from the data storage unit 36. The display unit 40 displays, on a display screen such as a display, the map data read from the data storage unit 36 by the system controller 20. The display unit 40 includes a graphic controller 41 for controlling the entire display unit 40 on the basis of the control data transmitted from the CPU 22 via the bus line 30, a buffer memory 42 having a memory such as a VRAM (Video RAM) for temporarily storing immediately displayable image information, a display control unit 43 for controlling a display 44 such as a liquid crystal and a CRT (Cathode Ray Tube) on the basis of the image data outputted from the graphic controller 41, and the display 44. The display 44 is formed by a liquid crystal display device of the opposite angle 5-10 inches, and is mounted in the vicinity of a front panel of the vehicle.

The sound output unit 50 includes a D/A converter 51 for executing D/A (Digital to Analog) conversion of the sound digital data transmitted from the CD-ROM drive 31, a DVD-ROM 32 or the RAM 24 via the bus line 30 under the control of the system controller 20, an amplifier (AMP) 52 for amplifying a sound analog signal outputted from the D/A converter 51, and a speaker 53 for converting the amplified sound analog signal into the sound and outputting it to the vehicle compartment.

The input device 60 includes keys, switches, buttons, a remote controller and a sound input device, which are used for inputting various kinds of commands and data. The input device 60 is arranged in the vicinity of the display 44 and a front panel of a main body of an on-vehicle electric system loaded on the vehicle. Additionally, in such a case that the display 44 is in a touch panel system, a touch panel provided on the display screen of the display 44 functions as the input device 60, too.

By executing the route search program stored in the ROM 23, the CPU 22 functions as the route calculation unit In addition, the map data illustrated in FIG. 1 is stored in the data storage unit 36.

### [Route Search Process]

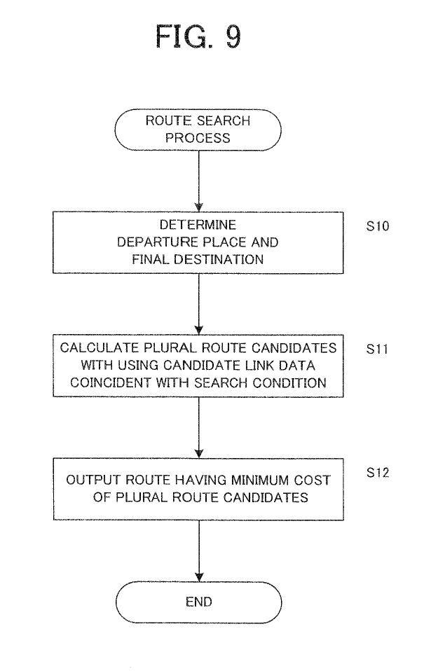

Next, a description will be given of a route search process. FIG. 9 shows a flow chart of the route search process. Actually, the CPU 22 executes the route search program, and the navigation apparatus 200 operates as the route search apparatus. Thereby, the route search process is executed.

First, the user who executes the route search uses the input device 60 in the navigation apparatus 200 to call the route search function. Then, the user designates and inputs the destination (final destination) and the search condition. In response, the CPU 22 determines the departure place and the destination for the route search (step S10). The position of the vehicle on which the navigation apparatus 200 is mounted is usually set to the departure place. When a terminal apparatus such as a PC is the route search apparatus, the user may designate the departure place.

Next, the CPU 22 reads, from the data storage unit 36, the route calculation data including the candidate link data corresponding to the search condition designated by the user, and calculates the candidate route to the destination (step S11). As described above, at this time, the CPU 22 determines whether or not the candidate link data exists in each node. Then, the CPU 22 calculates the candidate route based on the candidate link and the destination which the candidate link data shows, for the node at which the candidate link data exists. Meanwhile, the CPU 22 calculates the candidate route based on only the link along the road, for the node at which the candidate link data does not exist. In addition, the CPU 22 refers to the above-mentioned intermediate destination table, and replaces the destination, as needed.

In this manner, when obtaining the plural candidate routes from the departure place to the destination, the CPU 22 calculates the cost of each candidate route, and determines the candidate route having the minimum cost and shows the user the candidate route (step S12). Then, the route search process ends. The cost calculation is a technique generally used in the route calculation, which calculates the total of the costs corresponding to the links and the nodes. The value of the cost corresponding to the link and the node is set in advance based on various kinds of information such as a time and the number of lanes of the road necessary to pass through the link and the node. Since the cost calculation is a known method, a detailed explanation thereof is omitted.

In the above route search process, the candidate route is calculated with using only the link along the road at each node from the departure place to the destination, in principle. When it is necessary to include the link other than the link along the road as the subject of the calculation, the candidate link data showing the link is prepared. Therefore, when no candidate link data exists, the CPU 22 calculates the candidate route by using only the link along the road. When the candidate link data exists, the CPU 22 calculates the candidate route by using the candidate link shown by the candidate link data. Thus, the CPU 22 can rapidly calculate the long-distance route. In addition, since it is unnecessary to store the candidate link data at the node at which only the link along the road is used in the calculation, the total amount of data to be stored as the candidate link data can be significantly suppressed. Hence, it is unnecessary to prepare and store the large amount of special data, and the rapid route search becomes possible.

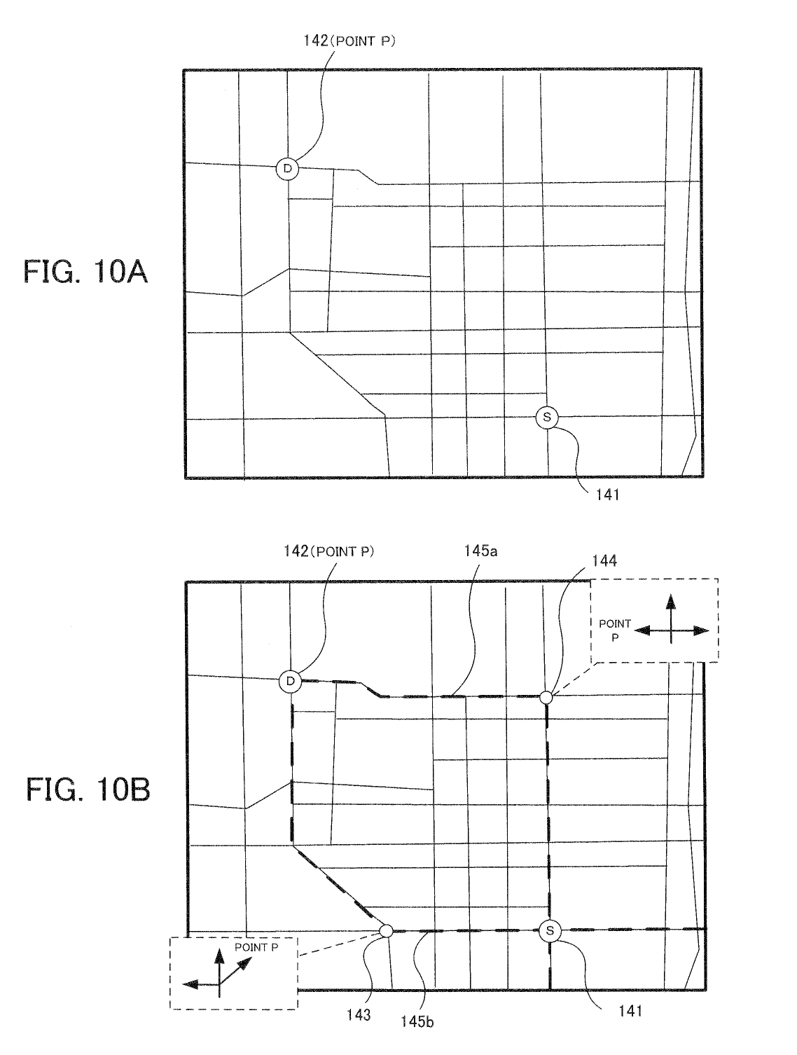

Next, an example of the route search according to this embodiment will be explained. Now, it is assumed that the route from a departure place 141 to a destination 142 (defined as “Point P”) on the map shown in FIG. 10A is searched. When the candidate link data according to this embodiment is not used, all the roads (links) shown in FIG. 10A are subjected to the route calculation, and the calculation amount becomes enormous.

On the other hand, according to this embodiment, the candidate link data is prepared at points 143 and 144 as shown in FIG. 10B. Thus, in the case of reaching the departure place 141 from the road on the lower side in FIG. 10B, since no candidate link data exists at each node up to the point 144, the link going along the road is chosen up to the point 144. Next, the candidate link data of the point 144 is referred to, and the candidate link in which “Point P” is shown as the destination is chosen (i.e., left-turn). Afterward, the link going along the road between the nodes at which no candidate link data exists is chosen, and the destination place 142 (Point P) is reached. In this manner, a candidate route 145a shown by a broken line is obtained. Similarly, in the case of reaching the departure point 141 from the road on the right side in FIG. 10B, since no candidate link data exists up to the point 143, the link along the road is chosen, and the candidate link toward the direction of the Point P shown by the candidate link data at the point 143 is chosen (i.e., going in the oblique right direction). Afterward, the link along the road is chosen, and the destination 142 is reached. In this manner, a candidate route 145b shown by a broken line is obtained.

According to this embodiment, since the route calculation is executed by using only the link along the road at the node at which no candidate link data exists, the links subjected to the calculation can be substantially reduced, and the rapid route calculation becomes possible. It is noted that, as shown in the above-mentioned example, the plural candidate routes to the destination can be obtained with using this embodiment.

### [Modification]

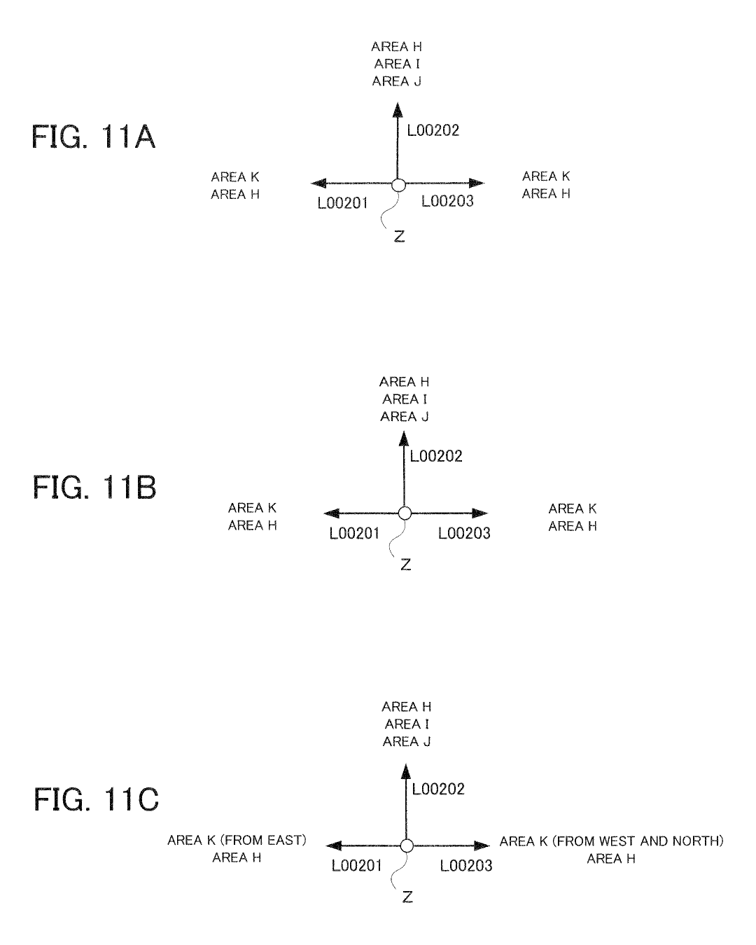

In the above example, the different destination is set to the different candidate link in the candidate link data. However, as shown in FIG. 11A, the same destination is sometimes set to the different candidate link. This is because, whichever candidate link may be used, the same destination can be sometimes reached in such a case that an area X is comparatively wide.

In addition, the example of the above candidate link data shows the candidate link data in the case of entering the node from one of the plural links connected to the certain node. However, in the case of entering the same node from the different link, the contents of the candidate link data becomes different. Namely, the candidate link data stored at the certain node is prepared and stored for each link connected to the node. For example, as for the node having the links in the north, south, east and west directions, the candidate link data independently becomes necessary in the case of entering the node from each direction. Thus, as the actual data, the candidate link data may be independently stored for each link connected to the node, or the candidate link data for all the links may be stored together.

FIG. 11B shows such an example in the case of storing the candidate link data together. In FIG. 11B, in the case of entering a node Z from a link L00201, links L00202 and L00203 become the candidate links. Meanwhile, in the case of entering the node Z from the link L00202, the links L00201 and L00203 become the candidate links. In the case of entering the node Z from the link L00203, the links L00201 and L00202 become the candidate links.

However, in this case, if the candidate link data in the case of entering the node Z from each link is simply stored together, the number of links subjected to the calculation may increase. In such a case, as shown by a parenthesis in FIG. 11C, by adding a condition of an entering direction, the increase of the unnecessary calculation amount can be prevented.

In the above-mentioned example, the candidate link data is prepared as the route calculation data. However data associated with the direction of turn at the intersection, names of the link and the corner and the place name is sometimes stored in the map data for the purpose of the route guidance. The route calculation may be executed with using such data as the above candidate link data. Conversely, the name of the direction may be guided with the sound by using the above candidate link data, and may be displayed in the display image of the map data as a direction board.

### INDUSTRIAL APPLICABILITY

This invention can be used for various kinds of terminal apparatuses including the function to search the route with using the map data. Concretely, this invention can be used for not only the car navigation apparatus but also a server apparatus for supplying route search service on the Web and an application for calculate a route on a PC with using map data downloaded from a server on the Web or map data stored onto a storage medium such as a DVD-ROM.

1-8. (canceled)

9. A route search apparatus comprising:
a storage unit which stores route calculation data that includes link data showing a link corresponding to a road, node data showing a node corresponding to a predetermined point on the road and candidate link data showing a link to be used in calculation of a candidate route via the node; and
a route calculation unit which executes route calculation with using the route calculation data,
wherein the route calculation unit executes the route calculation by using the link shown by the candidate link data at the node at which the candidate link data exists and by using a link along a road at the node at which the candidate link data does not exist.

10. The route search apparatus according to claim 9,
wherein the candidate link data is prepared for each search condition, and
wherein the route calculation unit executes the route calculation with using candidate link data corresponding to a search condition designated by a user.

11. The route search apparatus according to claim 9, wherein the route calculation unit uses only the link showing a destination, out of the links shown by the candidate link data.

12. The route search apparatus according to claim 9,
wherein the route calculation data is prepared for each of plural layers corresponding to different scales, and
wherein the candidate link data is prepared for the layer corresponding to at least a widest map.

13. The route search apparatus according to claim 9,
wherein the route calculation data includes an intermediate destination table showing correspondence of a final destination and an intermediate destination positioned on a route to the final destination, and
wherein the route calculation unit calculates the candidate route by prescribing the final destination and the intermediate destination as the destinations.

14. A route search method comprising a route calculation process which executes route calculation with using route calculation data that includes link data showing a link corresponding to a road, node data showing a node corresponding to a predetermined point on the road and candidate link data showing a link to be used in calculation of a candidate route via the node,
wherein the route calculation process executes the route calculation by using the link shown by the candidate link data at the node at which the candidate link data exists and by using the link along a road at the node at which the candidate link data does not exist.

15. A computer program product in a computer-readable medium for route search which is executed in a terminal apparatus comprising: a storage unit which stores route calculation data that includes link data showing a link corresponding to a road, node data showing a node corresponding to a predetermined point on the road and candidate link data showing a link to be used in calculation of a candidate route via the node; and a computer, and which makes the computer function as a route calculation unit that executes route calculation with using the route calculation data,
wherein the route calculation unit executes the route calculation by using the link shown by the candidate link data at the node at which the candidate link data exists and by using the link along a road at the node at which the candidate link data does not exist.
